(19) United States
(12) Patent Application Publication
(10) Pub. No.: US 2019/0068542 A1
(43) Pub. Date: Feb. 28, 2019

(54) FlyerLink

(71) Applicant: Elissa Dowden, Birmingham, AL (US)

(72) Inventor: Elissa Dowden, Birmingham, AL (US)

(21) Appl. No.: 15/692,095

(22) Filed: Aug. 31, 2017

(51) Int. Cl. H04L 12/58; G06Q 50/00; H04L 29/08

(52) U.S. Cl. CPC H04L 51/32; G06Q 50/01; G06F 3/0485; H04L 51/04; H04L 67/306; H04L 67/18

(57) ABSTRACT

The present invention generally relates to a new social media platform and more particularly to a travel-based social platform that connects users based on like travel itineraries, histories and interests.

There are known social media platforms in which users are connected based on broad categories of interest and circles of friends or colleagues. However, because these apps utilize on such broad categories of connection, users are limited to search criteria, recommended connections and their ability to view users without degrees of connection.

An object of the present invention is to provide a social media platform in which users can connect to other users without concern for degree of connection, but instead based on travel itineraries, schedules and interests while also consolidating their travel information into one application.

A secondary object of the present invention is to provide a platform where users can upload travel information from third party applications and platforms for a consolidated, all-inclusive look at their travel itineraries.

### TECHNICAL FIELD

The present invention generally relates to a new social media platform and more particularly to a travel-based social platform that connects users based on like travel itineraries, histories and interests.

### BACKGROUND ART

There are known social media platforms in which users are connected based on broad categories of interest and circles of friends or colleagues. However, because these apps utilize on such broad categories of connection, users are limited to search criteria, recommended connections and their ability to view users without degrees of connection.

### DISCLOSURE OF INVENTION

An object of the present invention is to provide a social media platform in which users can connect to other users without concern for degree of connection, but instead based on travel itineraries, schedules and interests.

In accordance with the present invention, there is provided a login screen with the opportunity to load existing social media platforms or connect organically; a user home page with the ability to edit personal, professional and travel information; a page with user-uploaded photo albums and the ability to share captions of related travel; a “FlyerLink” page which offers users a scrolling recommendation of connections to other users with travel itineraries, schedules, interests and geographical locations alike; a messaging platform where users can connect and exchange messages within the app; a link-request page where users can identify and accept or reject the opportunity to connect with users; a travel itinerary page, which imports airline seating charts and user-imported information regarding seat placement and each users' preference of communication and connection.

### SPECIFICATION EXAMPLE/DESCRIPTION OF DRAWINGS

FIG. 1 is a user profile view, illustrating the user's custom profile descriptions and information.

FIG. 2 is a user settings view, illustrating the user's ability to upload custom information.

The FlyerLink user will be able to upload personal and professional information to completely customize their profiles and travel and social preferences (1)

In addition to a FlyerLink custom profile, users can connect their external social networking sites (3) to share with other users and help import data.

In addition to social profiles, the users will be able to set their preferred airlines, hotels and airports (2)—helping them link to other travelers as well as connect their travel itineraries to the app.

FIG. 3 is an illustrated view of the user's home page, which connects them to different parts of the application. At the bottom of every screen the user will be provided with information regarding their travel itinerary and connected applications (1)

FIG. 4 is a user view of another user's profile. Users can see any information that another user has published including statuses (1) and information about interests, travel and social conversation preferences (2)

FIG. 5. is the “FlyerLink” connection page on which users can scroll through other users (1) with similar geographical locations, travel itineraries and interests.

FIG. 6 is the “upcoming flights” page where users can see an overview of their flight information (1) and see where other users are sitting on their flight (2). Users can click on seats to see an overview of user information and preferences (3).

FIG. 7 is the connections page, where users can preview connection requests before accepting new connections. Users will be able to see general information like professional title, interests and travel preferences (1).

FIG. 8 is the apps inbox, where users can exchange messages and communicate with one another from within the platform. Users can see an overview of the messages context (1) before opening each message.

FIG. 9 is a view of a user's scrolling picture albums, which are self-uploaded and captioned.

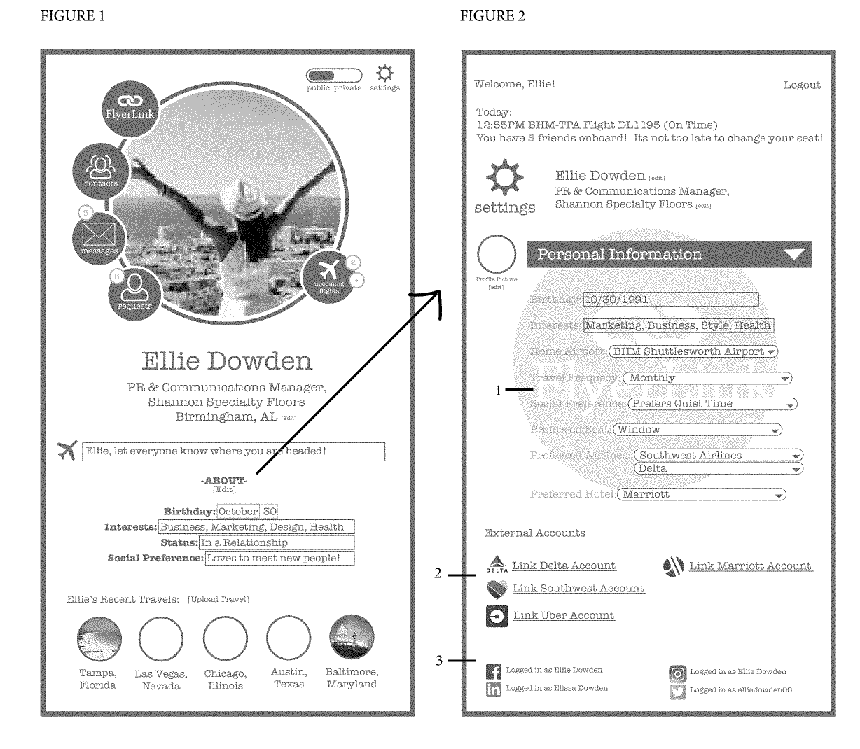

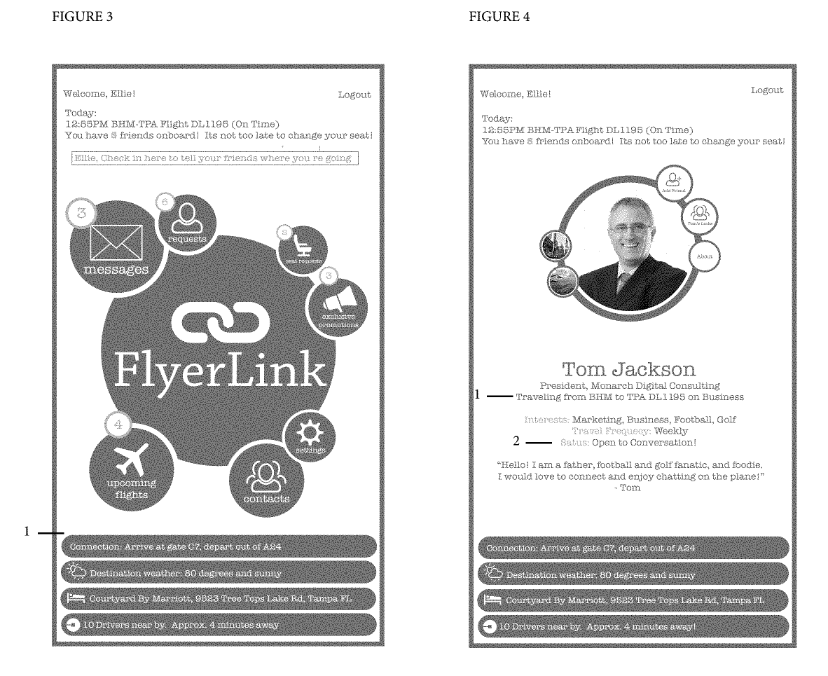

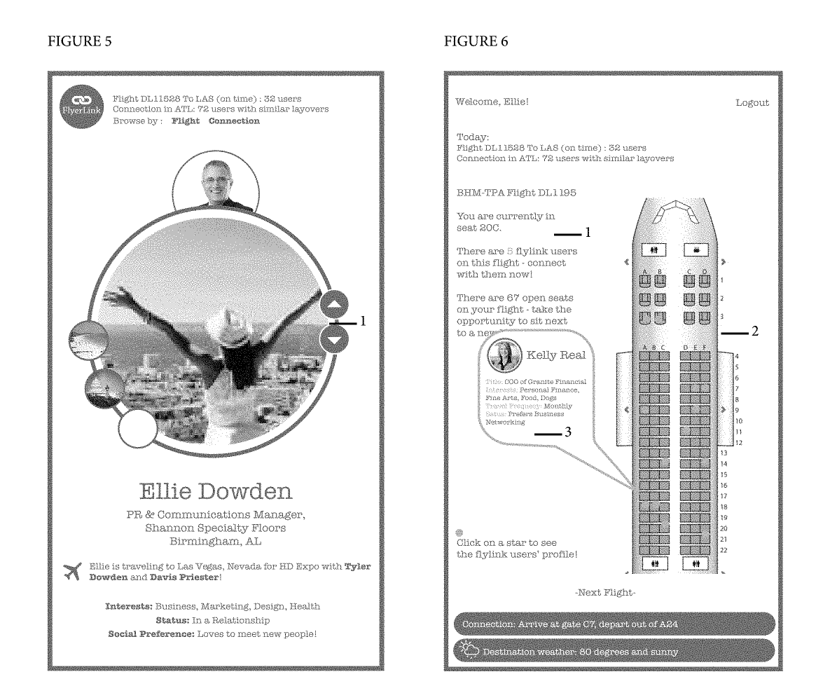

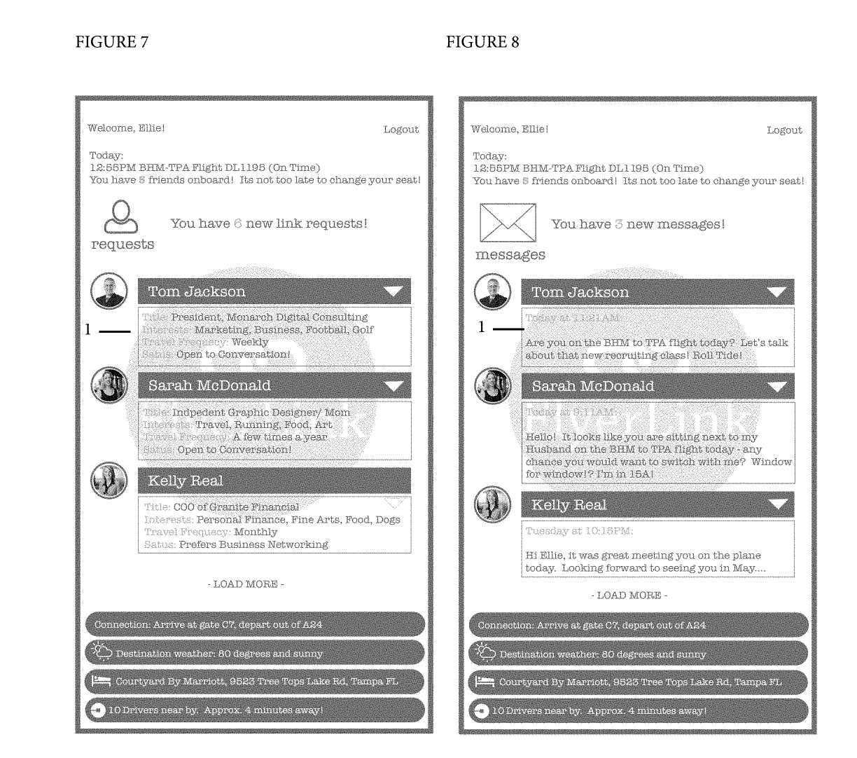

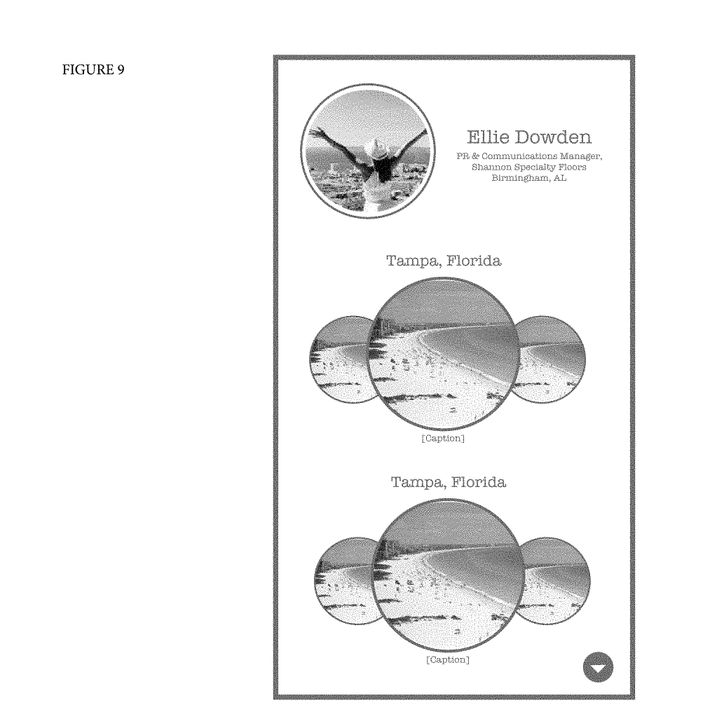

1. A travel-focused social media application and platform compromising:
(a) a user home page with the ability to edit personal, professional and travel information; (FIG. 2)
(b) a page with user-uploaded photo albums and the ability to share captions of related travel (FIG. 9)
(c) a “FlyerLink” page which offers users a scrolling recommendation of connections to other users with similar travel itineraries, schedules, interests and geographical locations; (FIG. 5)
(d) a messaging platform where users can connect and exchange messages within the app; (FIG. 8)
(e) a link-request page where users can identify and accept or reject the opportunity to connect with users; (FIG. 7)
(f) a travel itinerary page, which imports airline seating charts and user-imported information regarding seat placement and each users' preference of communication and connection. (FIG. 6)
(g) imported travel data from user imported data as well as connected applications and programs, which is used to provide a travel summary in this single application. (FIG. 3, 1)
whereby users can connect with other users based on targeted interest in travel, similar travel itineraries, interests and geographical location.
